(19) United States
(12) Patent Application Publication
(10) Pub. No.: US 2018/0028410 A1
(43) Pub. Date: Feb. 1, 2018

(54) DIGITAL CAP FOR MEDICINE CONTAINER AND CONTROL METHOD OF MOBILE DEVICE

(71) Applicant: LG ELECTRONICS INC., Seoul (KR)

(72) Inventors: Heeseong YUN, Seoul (KR); Kyuhyoung CHOI, Seoul (KR)

(73) Assignee: LG ELECTRONICS INC., Seoul (KR)

(21) Appl. No.: 15/549,341

(22) PCT Filed: Mar. 2, 2015
(86) PCT No.: PCT/KR2015/002003

§ 371 Date: Aug. 7, 2017

(30) Foreign Application Priority Data
Feb. 11, 2015 (KR) 10-2015-0020659

(51) Int. Cl. A61J 7/04; G08B 13/08

(52) U.S. Cl. CPC A61J 7/0436; A61J 7/0481; A61J 7/0418; G08B 13/08; A61J 2200/30

(57) ABSTRACT

Disclosed are a digital cap for a medicine container, a control method of a mobile device, etc. The digital cap, according to an embodiment of the present invention, comprises: a fastening module connectable to a medicine container, a communication module for receiving, from a mobile device, at least one if medication time and the type of medicine contained within the medicine container; a detection module for scanning whether the connected medicine container has been opened or closed; an output module for outputting an alarm which restricts medication when the opening and closing is sensed and if the current time is not within the range of the received medication time; a controller for transmitting information regarding the opening and closing to the mobile device by controlling the communication module; and a battery for supplying power to at least one of the elements.

### TECHNICAL FIELD

The present invention relates to a technology for a digital cap for a medicine container and a mobile device. For example, the present invention can be applied to a pairing technology for pairing between a cap capable of being connected to a medicine container and a mobile device. In this case, the mobile device may correspond to a cellular phone, a tablet PC, a notebook, and the like.

### BACKGROUND ART

Recently, interest in health is increasing and a type of medicine taken by people is geometrically increasing as well. While it is important to take a medicine at an appointed time, it is not easy for a busy modern man not to forget the medication time.

### DISCLOSURE OF THE INVENTION

### Technical Tasks

An object of the present invention is to solve the aforementioned problem and other problems.

Another object of the present invention is to provide a digital cap capable of periodically monitoring medication time and a mobile device according to one embodiment of the present invention.

Another object of the present invention is to provide a digital cap capable of managing a history of medication according to a user and a mobile device according to a different embodiment of the present invention.

The other object of the present invention is to provide a technology of automatically customizing medication time and medication period based on a medication history of a user according to a further different embodiment of the present invention.

Technical tasks obtainable from the present invention are non-limited the above mentioned technical tasks. And, other unmentioned technical tasks can be clearly understood from the following description by those having ordinary skill in the technical field to which the present invention pertains.

### Technical Solution

To achieve these and other advantages and in accordance with the purpose of the present invention, as embodied and broadly described, according to one embodiment, a digital cap for a medicine container includes a fastening module capable of being connected with the medicine container, a communication module configured to receive at least one of a type of medicines contained in the medicine container and medication time from a mobile device, a detect module configured to detect whether or not the connected medicine container is opened/closed, if whether or not the connected medicine container is opened/closed is detected and current time is not a range of the received medication time, an output module configured to output an alarm for setting a limit on medication, a controller configured to control the communication module to transmit information on whether or not the connected medicine container is opened/closed to the mobile device, and a battery configured to supply power to at least one of the aforementioned configuration elements.

To further achieve these and other advantages and in accordance with the purpose of the present invention, according to a different embodiment, a method of controlling a mobile device, includes the steps of receiving a first data indicating a type of medicine contained in a medicine container or medication time, transmitting the received data to a digital cap for the medicine container, receiving a second data indicating whether or not the medicine container is opened/closed from the digital cap, and changing the medication time based on the received second data.

### Advantageous Effects

Advantage and effectiveness of a display device capable of recognizing voice according to the present invention and a method of controlling therefor are described in the following.

According to at least one of embodiments of the present invention, it is able to periodically monitor medication time although a user does not separately remember the medication time.

According to a different embodiment of the present invention, it is able to provide a digital cap capable of managing a medication history according to a user and a mobile device.

According to a further different embodiment of the present invention, it is able to provide a technology of automatically customizing medication timing and a period based on a user according to a medication history of the user.

An additional scope to which the present invention is applicable is going to be clearly understood based on the following detail description. Various changes and modifications can be clearly understood by those skilled in the art within the idea and the scope of the present invention. Hence, specific embodiment such as the detail description and preferred embodiment of the present invention should be understood as a given example.

### DESCRIPTION OF DRAWINGS

FIG. 1 is a diagram for exteriors of a digital cap and a mobile device according to one embodiment of the preset invention;

FIG. 2 is a block diagram for configuration elements of a digital cap according to one embodiment of the present invention;

FIG. 3 is a detail block diagram for a side view of a digital cap according to one embodiment of the present invention;

FIG. 4 is a perspective diagram for an exterior of a digital cap shown in FIG. 3;

FIGS. 5 to 8 are diagrams for explaining a process of registering medication information according to one embodiment of the present invention;

FIG. 9 is a flowchart for explaining a process of pairing a mobile device and a digital cap according to one embodiment of the present invention;

FIGS. 10 to 13 are diagrams for explaining a process of displaying medication information displayed by a mobile device according to one embodiment of the present invention;

FIG. 14 is a diagram for explaining a process of automatically controlling medication time/period according to one embodiment of the present invention;

FIGS. 15 and 16 are flowcharts for a method of providing a medication alarm according to one embodiment of the present invention;

FIGS. 17 to 19 are diagrams for explaining a process of registering a medicine including no period according to one embodiment of the present invention;

FIGS. 20 to 22 are diagrams for explaining a process of registering a medicine including a period according to one embodiment of the present invention;

FIGS. 23 and 24 are diagrams of GUI for managing medication adherence according to one embodiment of the present invention;

FIG. 25 is a flowchart for a method of calculating medication adherence according to one embodiment of the present invention;

FIGS. 26 to 28 are diagrams of GUI for providing an alarm related to medication adherence according to one embodiment of the present invention;

FIGS. 29 and 30 are diagrams for explaining a process of recommending an automatic medication time change according to one embodiment of the present invention;

FIGS. 31 and 32 are diagrams for explaining a process of providing medication information by voice according to one embodiment of the present invention;

FIGS. 33 and 34 are diagrams for explaining a process of providing battery and refill warning according to one embodiment of the present invention;

FIG. 35 is a flowchart for a method of pairing a digital cap and a mobile device according to one embodiment of the present invention;

FIG. 36 is a flowchart for a method of transmitting update information transmitted by a digital cap and a mobile device according to one embodiment of the present invention;

FIG. 37 is a flowchart for a method of controlling a mobile device according to one embodiment of the present invention.

### BEST MODE

Description will now be given in detail according to exemplary embodiments disclosed herein, with reference to the accompanying drawings. For the sake of brief description with reference to the drawings, the same or equivalent components may be provided with the same reference numbers, and description thereof will not be repeated. In general, a suffix such as “module” and “unit” may be used to refer to elements or components. Use of such a suffix herein is merely intended to facilitate description of the specification, and the suffix itself is not intended to give any special meaning or function. In the present disclosure, that which is well-known to one of ordinary skill in the relevant art has generally been omitted for the sake of brevity. The accompanying drawings are used to help easily understand various technical features and it should be understood that the embodiments presented herein are not limited by the accompanying drawings. As such, the present disclosure should be construed to extend to any alterations, equivalents and substitutes in addition to those which are particularly set out in the accompanying drawings.

It will be understood that although the terms first, second, etc. may be used herein to describe various elements, these elements should not be limited by these terms. These terms are generally only used to distinguish one element from another.

It will be understood that when an element is referred to as being “connected with” another element, the element can be connected with the other element or intervening elements may also be present. In contrast, when an element is referred to as being “directly connected with” another element, there are no intervening elements present.

A singular representation may include a plural representation unless it represents a definitely different meaning from the context.

Terms such as “include” or “has” are used herein and should be understood that they are intended to indicate an existence of several components, functions or steps, disclosed in the specification, and it is also understood that greater or fewer components, functions, or steps may likewise be utilized.

A mobile terminal described in the present specification can include a cellular phone, a smartphone, a laptop computer, a digital broadcast terminal, a personal digital assistant (PDA), a portable multimedia player (PMP), a navigator, a slate PC, a tablet PC, a ultra-book, a wearable device (e.g., a smart watch, a smart glass, a head mounted display (HMD)), and the like.

Except a case applied to a mobile terminal only, it is apparent to those skilled in the art that the configuration according to embodiments of the present specification can also be applied to such a stationary terminal as a digital TV, a desktop computer, a digital signage, etc.

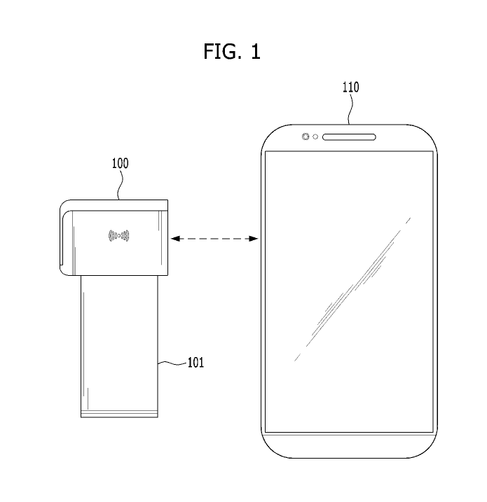

FIG. 1 is a diagram for exteriors of a digital cap and a mobile device according to one embodiment of the preset invention. Although FIG. 1 illustrates an example that a digital cap 100 and a mobile device 110 are in a state of being paired by Bluetooth, or the like according to one embodiment of the present invention, it is apparent that the digital cap 100 itself not equipped with a communication function also belongs to the different scope of right of the present invention.

Meanwhile, the digital cap 100 according to one embodiment of the present invention is designed by a structure capable of being connected with a medicine container 101. As mentioned in the foregoing description, the mobile device 110 may correspond to a smartphone, a cellular phone, a tablet PC, a notebook, or the like and is connected with the digital cap 100 in wired or wireless.

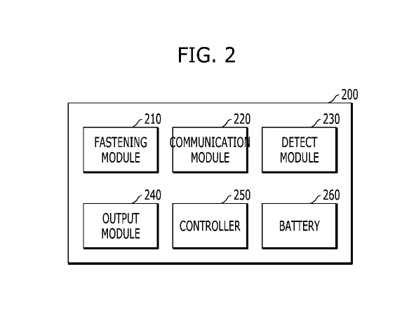

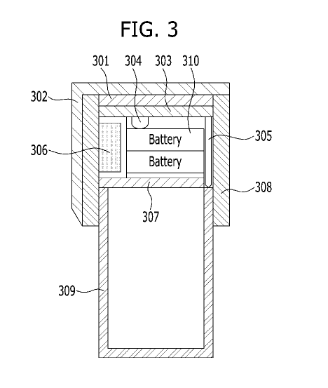

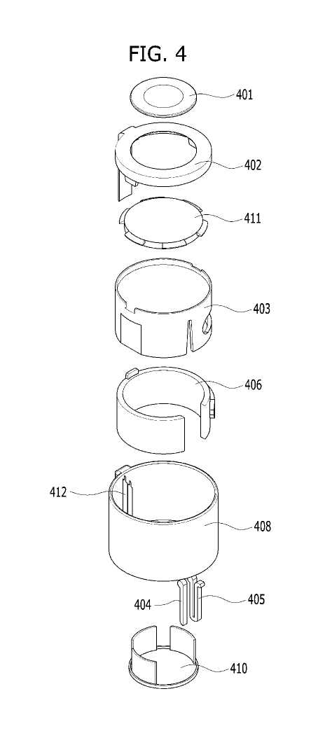

The digital cap 100 shown in FIG. 1 shall be described later in more detail with reference to FIGS. 3 and 4 in the following. The mobile device 100 shown in FIG. 1 is explained with reference to FIG. 2.

FIG. 2 is a block diagram for configuration elements of a digital cap according to one embodiment of the present invention

As shown in FIG. 2, a digital cap 200 according to one embodiment of the present invention includes a fastening module 210, a communication module 220, a detect module 230, an output module 240, a controller 250, and a battery 260. Of course, removing, changing, or adding a partial module according to the necessity of those skilled in the art can also belong to the scope of right of the present invention.

First of all, the fastening module 210 is configured to connect a medicine container and the digital cap with each other. For example, the medicine container corresponds to the medicine container 101 shown in FIG. 1. The medicine container is designed by a prescribed size according to a country.

The communication module 220 is configured to receive at least one of a type of medicine included in the medicine container and medication time and the detect module 230 is configured to detect whether the connected medicine container is opened or closed.

If the opening/closing of the medicine container is detected and current time is not within the range of the received medication time, the output module 240 outputs an alarm to set a limit on taking a medicine. The controller 250 controls the communication module 220 to transmit information on the opening/closing of the medicine container to the mobile device. The battery 260 supplies power to at least one of the aforementioned configuration elements. In particular, when the digital cap is designed according to one embodiment of the present invention, efficiently designing a position of the battery configured to supply power to each configuration element is an important issue. Regarding this, it shall be described in more detail with reference to FIG. 3.

For example, the output module 240 may correspond to at least one of a speaker and a display. Moreover, if the remaining power of the battery 260 is equal to or less than a predetermined level or the number of medicines included in the medicine container is less than a predetermined number, the output module 240 outputs a warning alarm in an audio form or a video form.

The controller 250 is configured to calculate the remaining amount of medicines included in the medicine container based on the total number of firstly registered medicines received via the communication module 220, information on one time dosage, and the count of closing/opening the medicine container detected by the detect module 230.

Although it is not depicted in FIG. 2, the digital cap 200 further includes a memory configured to store the medication time. In this case, the controller 250 updates time of opening/closing the medicine container in the memory and changes the received medication time based on the updated information.

The controller 250 is configured to determine whether or not the medicine container is opened at the received medication time. Moreover, if a probability of opening the medicine container at the medication time satisfies a first range, the communication module 220 transmits data to the mobile device to indicate a related result to the mobile device.

Meanwhile, if a probability of opening the medicine container at the medication time satisfies a second range, the communication module 220 transmits data to a different external device rather than the mobile device to indicate a related result to the external device. For example, the communication module 220 is configured to perform communication with the mobile device based on NFC or Bluetooth.

FIG. 3 is a detail block diagram for configuration elements of a digital cap according to one embodiment of the present invention.

A push button 301 corresponds to a button for operating a medicine container. The push button executes medication instruction voice guide and executes a snooze function when a medication alarm is outputted. If a digital lamp is mounted on the push button 301, it may be able to display the number of medicines to take.

An LED lamp reflector 302 makes a lamp light to be recognized at the top or a side of the medicine container and makes a user check the lamp light irrespective of a position at which the medicine container is located.

A PCB 303 corresponds to an MCU for managing medication time, a medication alarm, and a medication history. For example, the PCB plays a role of a controller. Moreover, the PCB can be designed by a Bluetooth chip providing wireless communication. A sound chip configured to control voice storage and output is also embedded in the PCB.

A reset switch 304 is in charge of a function of resetting stored medication information when the reset switch is clicked.

An open/close switch 305 has a form of on/off and is able to recognize whether or not a lid covers a pill box (medicine container). The open/close switch may correspond to the aforementioned detect module.

A speaker 306 includes a high-capacity speaker capable of outputting audio. A cover 307 provides a sealing function to easily keep a stored medicine.

A case body 308 provides a waterproof function and a dustproof function. A pill box can include a medicine container commonly used in many countries or an individual medicine container. The pill box plays a role of a fastening module.

A battery 310, for example, uses two CR2450 Lithium batteries. Of course, a different type of batteries can be adopted as well. Moreover, if it is designed as shown in FIG. 3 in consideration of a relation with the speaker 306, it may have an advantage capable of increasing speaker capacity or battery capacity. FIG. 4 is a perspective diagram for an exterior of a digital cap shown in FIG. 3. Those skilled in the art can interpret FIG. 4 with reference to FIG. 3. In this case, the same number corresponds to the same module.

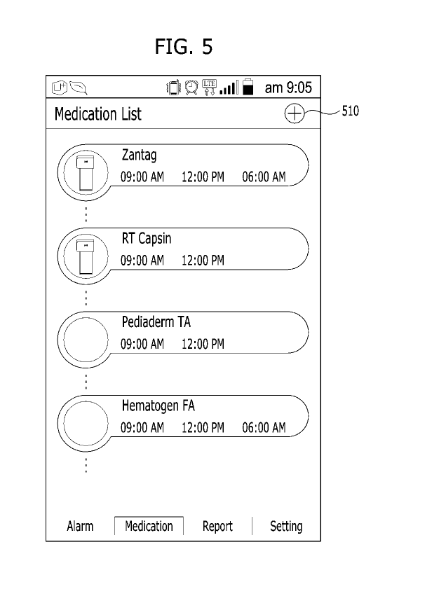

FIGS. 5 to 8 are diagrams for explaining a process of registering medication information according to one embodiment of the present invention.

A function according to one embodiment of the present invention can be installed in a mobile device by default or can be downloaded to the mobile device in a form of an application. The application downloaded to the mobile device is configured to register medication information without interlocking with a digital cap to enable medication notification, medication information inquiry, and medication alarm. If the application is interlocked with the digital cap, it may be able to transmit and receive data via an NFC tag.

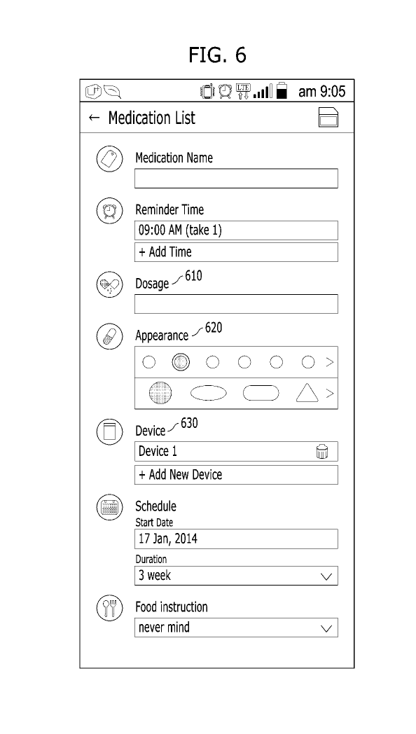

First of all, as shown in FIG. 5, the mobile device outputs a list of currently registered medicines. If a specific tab 510 is selected, as shown in FIG. 6, information capable of adding or modifying medication information is displayed.

If a first option 610 shown in FIG. 6 is selected, it may be able to input detail medication information. The inputted detail medication information is interlocked with the digital cap and can be outputted by voice via NFC tag.

If a second option 620 shown in FIG. 6 is selected, it may be able to register appearance, color, and the like of a medicine. If a third option 630 shown in FIG. 6 is selected, it may be able to register a digital cap to be interlocked with the application in advance.

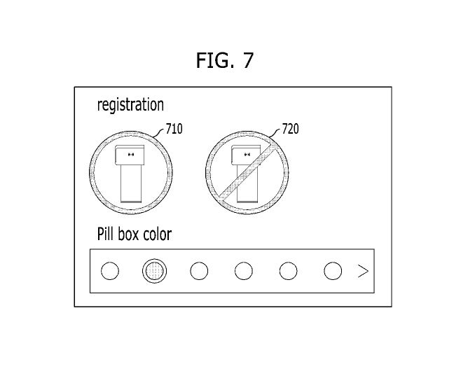

Moreover, as shown in FIG. 7, a fourth option 710 for registering a new medicine and a fifth option 720 for eliminating a previously registered medicine are displayed. If the fourth option 710 shown in FIG. 7 is selected, a message for asking whether to register a new medicine is outputted. After the fourth option is selected, if a button of a digital cap (also referred to as an electronic medicine container) is pushed and NFC tagging is performed on the mobile device, such information as a medicine name, dosage, medication time, and the like are transmitted to the digital cap.

On the contrary, if the fifth option 720 shown in FIG. 7 is selected, a message for asking whether to eliminate a registered pill box is outputted. Moreover, as shown in FIG. 7, If UI for selecting color of a pill box is outputted when a pill box is registered, a user can easily identify a pill box preferred by the user using color only.

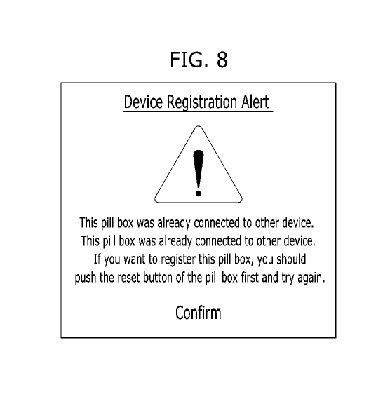

Meanwhile, if a user attempts to register a different medicine at a previously registered pill box (digital cap), as shown in FIG. 8, a message is outputted to indicate that the pill box has already been registered. Hence, it may be able to reduce a mistake that the user registers a different medicine at the same pill box (digital cap).

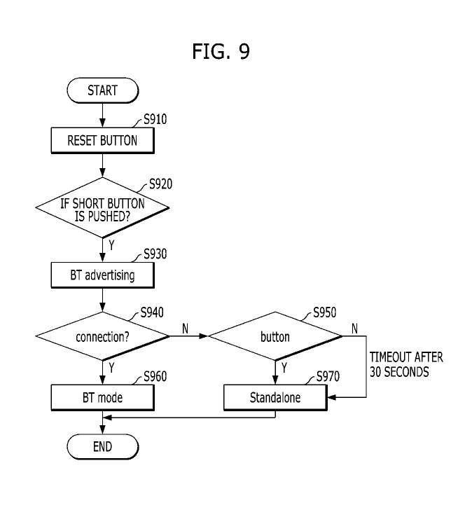

FIG. 9 is a flowchart for explaining a process of pairing a mobile device and a digital cap according to one embodiment of the present invention. FIG. 9 is described in the aspect of a digital cap.

First of all, if a reset button of a digital cap is pushed [S910], information stored in a memory is reset. Subsequently, whether or not a short button is pushed is determined [S920]. If the short button is pushed, BT (Bluetooth) advertising is executed [S930]. For example, it may be able to configure a light positioned at the edge of a digital cap to flicker once every three seconds to inform a user that Bluetooth pairing is in progress. More specifically, for example, it may be able to configure the light to be turned on during 0.5 second and to be turned off during 2.5 seconds.

Whether or not the Bluetooth pairing is performed is determined [S940]. If a connection is not established, whether or not a button of the digital cap is pushed is determined [S950]. If the button is pushed or a special action is not sensed within 30 seconds, the digital cap according to one embodiment of the present invention operates in a standalone mode [S970]. In particular, implementing the present invention without data communication with the mobile device also belongs to the scope of right of the present invention.

On the contrary, if the connection is established, the digital cap operates in a Bluetooth mode [S960]. In particular, the digital cap according to one embodiment of the present invention and the mobile device are configured to transceive at least one data with each other.

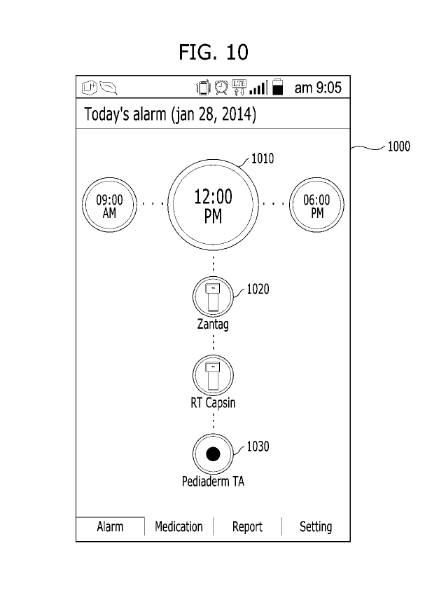

FIGS. 10 to 13 are diagrams for explaining a process of displaying medication information displayed by a mobile device according to one embodiment of the present invention.

As shown in FIG. 10, the mobile device 100 according to one embodiment of the present invention outputs a medication list at corresponding medication time 1010. For example, if a first digital cap mapped to a previously registered first medicine is interlocked with the mobile device 1000, an image 1020 of the first digital cap is outputted. As mentioned in the foregoing description, it may be able to identify a digital cap using a color.

On the contrary, if a second digital cap mapped to a previously registered second medicine is not interlocked with the mobile device 1000, appearance, image, or color 1030 of the medicine itself.

When a digital cap is interlocked with a mobile device, if a lid of the digital cap is opened and closed, corresponding time is recognized and stored as medication time and the medication time is transmitted to the mobile device. Of course, the digital cap may autonomously output medication time alarm in a display or an audio form.

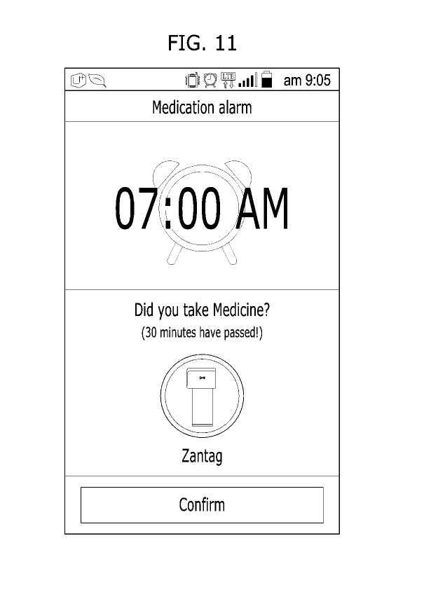

Moreover, if a signal indicating the completion of the medication (e.g., open and close of the lid) is not received during 30 minutes after the medication time shown in FIG. 10, as shown in FIG. 11, a pop-up message is outputted to inform a user of the medication time one more time after 30 minutes from the medication time.

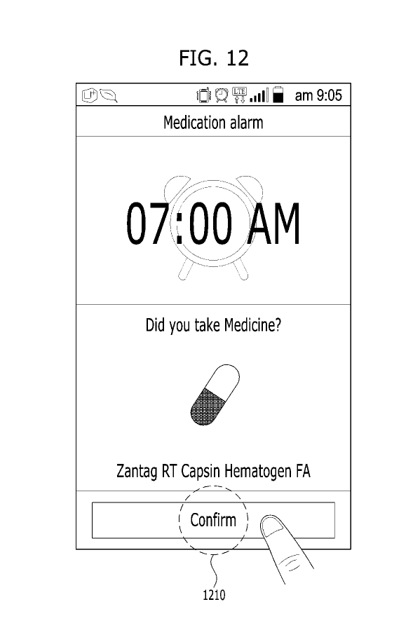

On the contrary, if the digital cap is not interlocked with the mobile device, as shown in FIG. 12, a message is outputted to ask whether or not a user takes a medicine. It may also be able to manually input medication time by selecting a specific tab 1210.

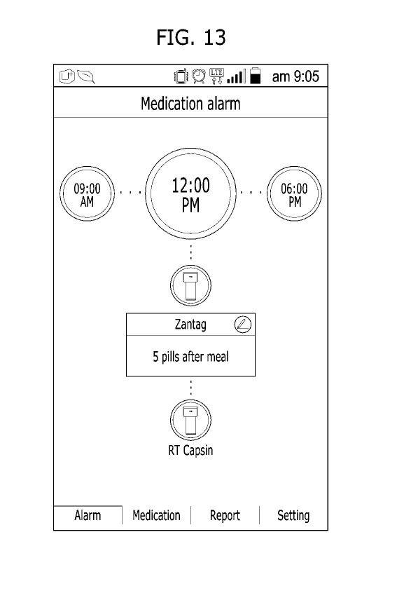

If a specific medicine is selected from the list of medicines shown in FIG. 10, as shown in FIG. 13, medication summary information is displayed. Of course, outputting the medication summary information as audio data also belongs to the scope of right of the present invention.

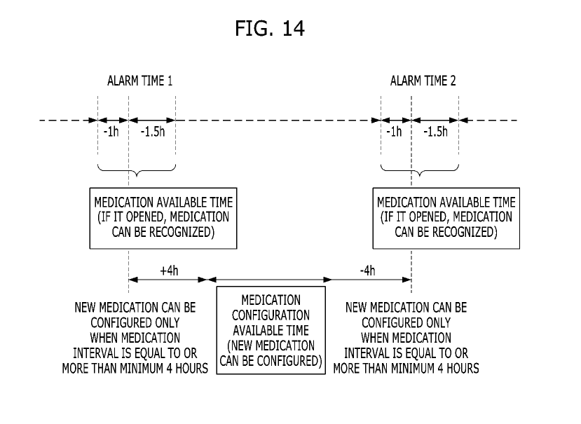

FIG. 14 is a diagram for explaining a process of automatically controlling medication time/period according to one embodiment of the present invention.

Medication time can be set maximum 6 times a day with a time interval of minimum 4 hours. For example, as shown in FIG. 14, an hour before configured alarm time 1 and configured alarm time 2 and an hour and a half after the configured alarm time 1 and the configured alarm time 2 can be configured as medication available time.

Yet, a different characteristic of the present invention is to automatically change medication time configured by a user according to necessity. For example, when a user sets medication time to 9 o'clock, if the user repeatedly takes a medicine at 9:30, medication time alarm is set to 9:30 by delaying 30 minutes. Meanwhile, as mentioned in the foregoing description, information on whether or not a user takes a medicine is received from the digital cap. More specifically, the information can be determined based on a state of a lid (open/close) near the medication time (e.g., between before 30 minutes and after an hour and a half). In particular, if the lid is opened and closed at different time, it is considered as medication is not performed.

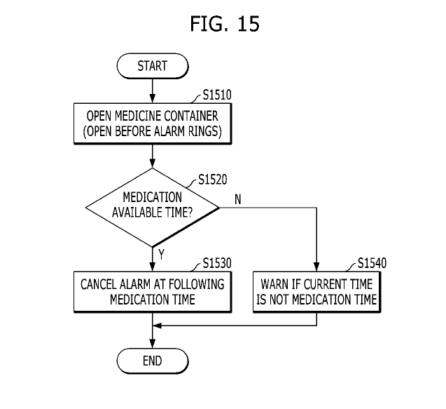

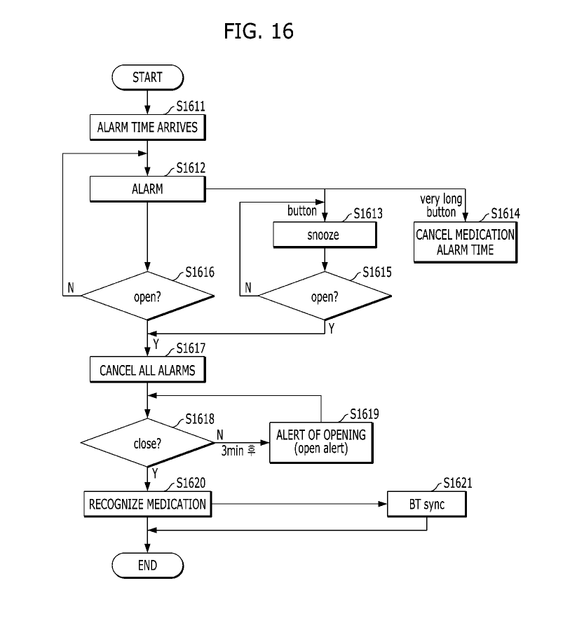

FIGS. 15 and 16 are flowcharts for a method of providing a medication alarm according to one embodiment of the present invention. FIG. 15 shows a first embodiment that a digital cap according to the present invention provides a medication alarm to a user and FIG. 16 shows a second embodiment that a digital cap according to the present invention provides a medication alarm to a user.

First of all, as shown in FIG. 15, a lid of a digital cap is opened [S1510]. In this case, whether or not current time corresponds to medication available time is determined [S1520]. As a result, if the current time is not the medication available time, a warning message is outputted in a voice form or a display form to indicate that the current time is not the medication time [S1540]. On the contrary, if the current time corresponds to the medication available time, it may be able to configure an alarm to be cancelled at following medication time [S1530].

Meanwhile, as shown in FIG. 16, if medication alarm time arrives [S1611], the digital cap or the mobile device outputs an alarm [S1612].

If a button mounted on a lid of the digital cap is touched for more than prescribed time, medication alarm time is cancelled [S1614]. Meanwhile, if the button is touched during time (e.g., short touch button) rather than the predetermined time, a snooze function is executed [S1615] and whether or not the lid of the digital cap is opened is determined [S1615].

Meanwhile, whether or not the lid is opened is determined without the button input mentioned earlier in the step S1613 or the step S1614 [S1616]. If the lid is opened, all alarms are cancelled [S1617]. Whether or not the lid of the digital cap is closed again is determined [S1618]. If 3 minutes (changeable) are elapsed while the lid is not closed, a message is outputted to warn the open state [S1619] to induce the user to close the lid.

On the contrary, if the lid is closed again, it is recognized as medication is performed [S1620] and Bluetooth mode is executed [S1621]. The Bluetooth mode of the step 1621 means that information on the open/close of the lid of the digital cap and time are able to be transmitted to the mobile device, which is connected via Bluetooth sync.

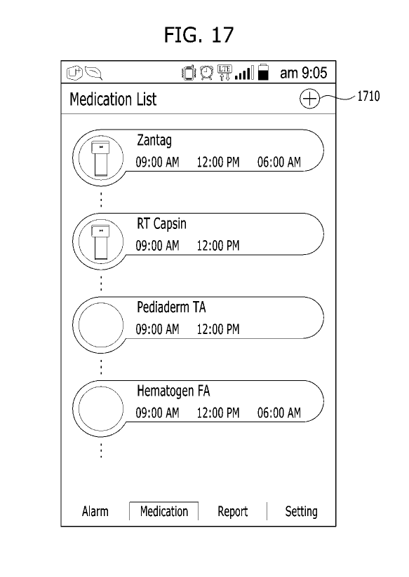

FIGS. 17 to 19 are diagrams for explaining a process of registering a medicine including no period according to one embodiment of the present invention. FIGS. 17 to 19 correspond to embodiments for PRN (pro re nata) such as a fever reducer, which is taken without a determined period according to necessity. The PRN is registered without medication time information.

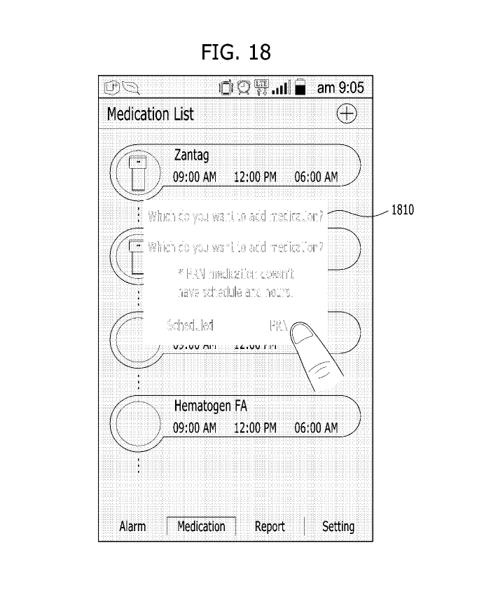

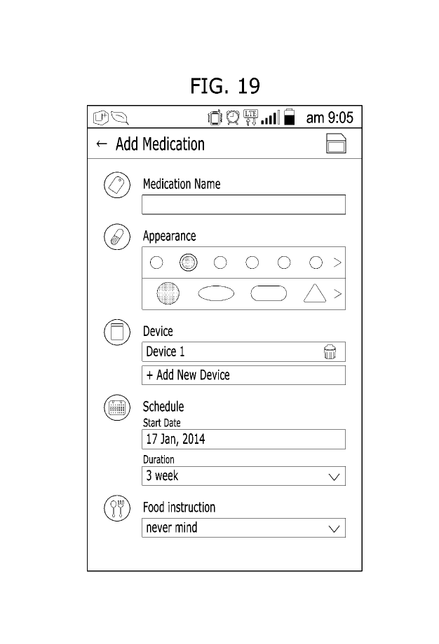

First of all, if a graphic shown in FIG. 17 is outputted on a mobile device and a predetermined tab 1710 is selected, as shown in FIG. 18, a message 1810 is outputted to ask which medicine is to be selected. Since it is a process of selecting the PRN, as shown in FIG. 19, medication time, number, and period information for the PRN are configured to be omitted.

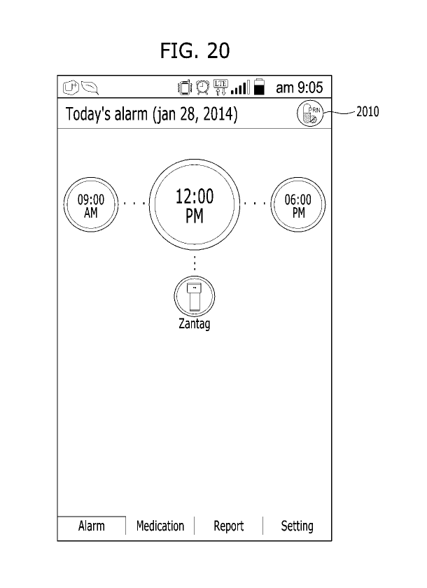

FIGS. 20 to 22 are diagrams for explaining a process of registering a medicine including a period according to one embodiment of the present invention. As shown in FIGS. 20 to 22, in case of PRN, if it exceeds a medication period or dosage configured at setting, it may be able to configure an appropriate warning message to be popped up in the mobile device itself or an application of the mobile device.

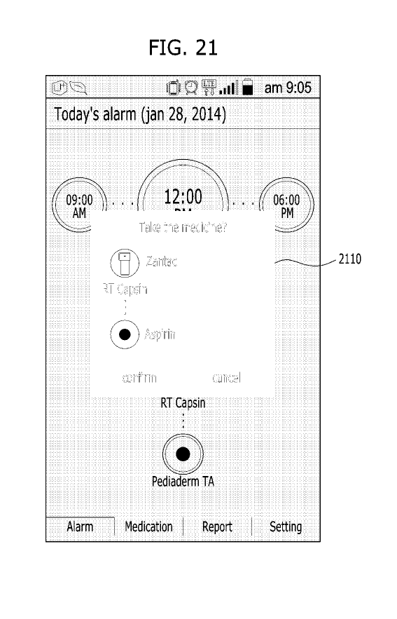

First of all, as shown in FIG. 20, if a PRN icon 2010 is displayed and the PRN icon is selected, as shown in FIG. 21, a message 2110 capable of checking whether or not a user takes a specific PRN is outputted.

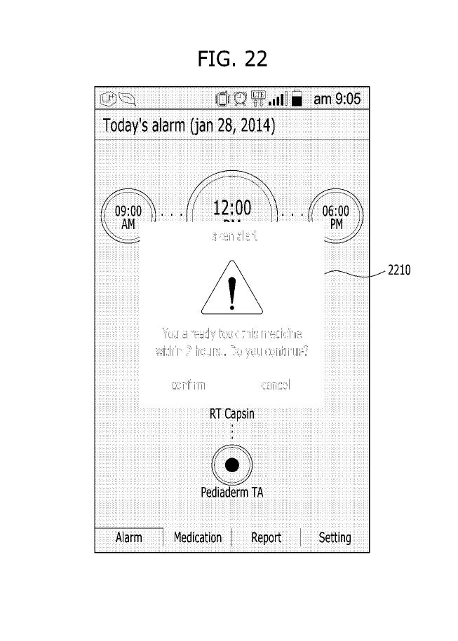

In this case, if a user takes excessive medication within a recommended period, as shown in FIG. 22, a warning message 2210 is outputted.

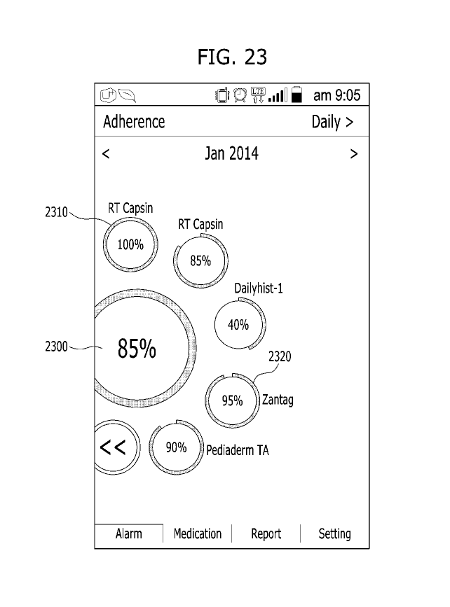

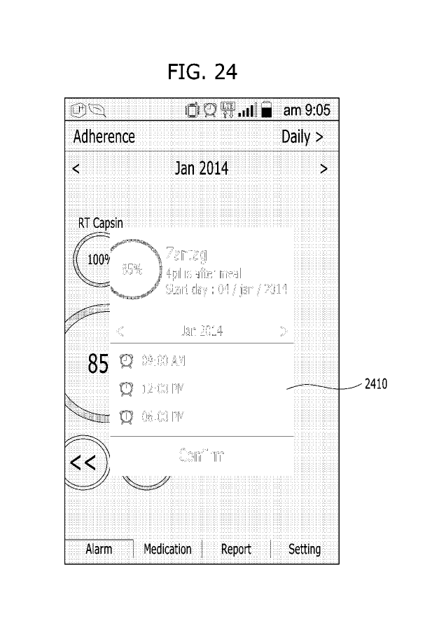

FIGS. 23 and 24 are diagrams of GUI for managing medication adherence according to one embodiment of the present invention. As shown in FIGS. 23 and 24, it is able to quickly check medication coherence of a registered medicine. If a coherence circle of an individual medicine is selected, a detail medication history is displayed.

First of all, as shown in FIG. 23, medication coherence of all registered medicines is displayed by a number 2300 and individual coherence of each medicine is displayed by numbers 2310/2320 in the vicinity of the number 2300.

In this case, if specific medication coherence 2320 is selected, as shown in FIG. 24, a medication history 2410 of the selected medicine is displayed in a predetermined order. For example, the predetermined order corresponds to a chronological order.

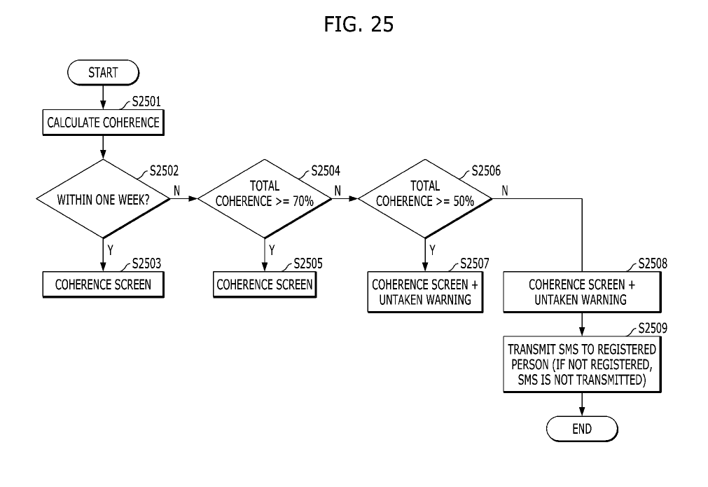

FIG. 25 is a flowchart for a method of calculating medication adherence according to one embodiment of the present invention. A process of calculating a medication coherence state in a weekly unit and reporting the medication coherence state using a pop-up is explained with reference to FIG. 25. The process described in FIG. 25 can be processed in a mobile device or a digital cap.

First of all, medication coherence of an individual medicine is calculated [S2501] and whether or not the medication coherence is within a week is determined [S2502]. If the medication coherence is within a week, a coherence screen is displayed [S2503]. If the medication coherence is not within a week, whether or not the whole coherence is equal to or greater than 70% is determined [S2504].

If the whole coherence is equal to or greater than 70%, a coherence screen is displayed [S2505]. Otherwise, whether or not the whole coherence is equal to or greater than 50% is determined again [S2506]. As a result, if the whole coherence is equal to or greater than 50%, a coherence screen and a message for warning non-medication are displayed [S2507].

On the contrary, if the whole coherence is not equal to or greater than 50%, a coherence screen and a message for warning non-medication are displayed [S2508] and an SMS text message is transmitted to a registered mobile number [S2509]. The registered mobile number may correspond to a telephone number of a family member.

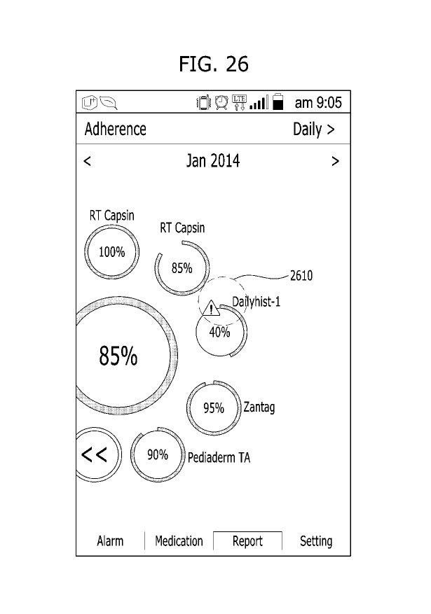

FIGS. 26 to 28 are diagrams of GUI for providing an alarm related to medication adherence according to one embodiment of the present invention. If medication coherence is equal to or less than a predetermined threshold value, a message for warning too low medication coherence is automatically transmitted to emergency contact registered at the setting.

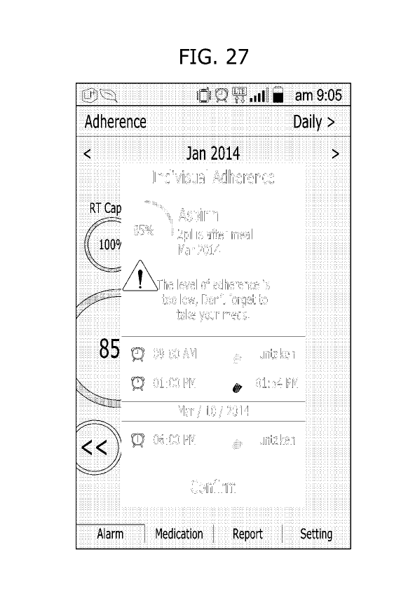

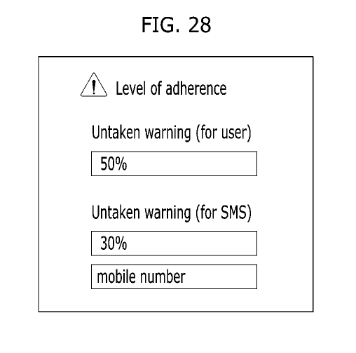

First of all, as shown in FIG. 26, a warning icon 2610 is displayed on a specific medicine that medication coherence is equal to or less than 50%. If the warning icon is selected, as shown in FIG. 27, coherence details and a warning message are displayed. Meanwhile, as shown in FIG. 28, when medication coherence is equal to or less than a coherence reference or a specific coherence value, it may be able to provide an option capable of designating a mobile number to which a warning message is automatically transmitted.

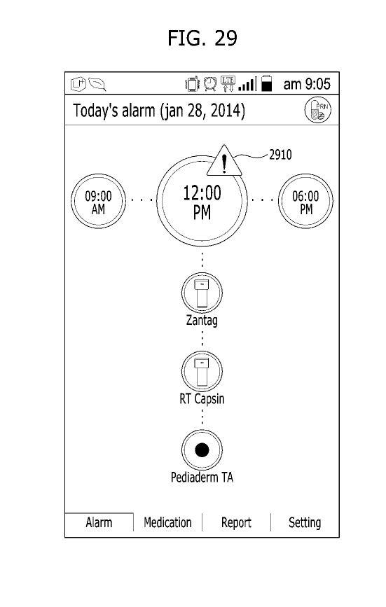

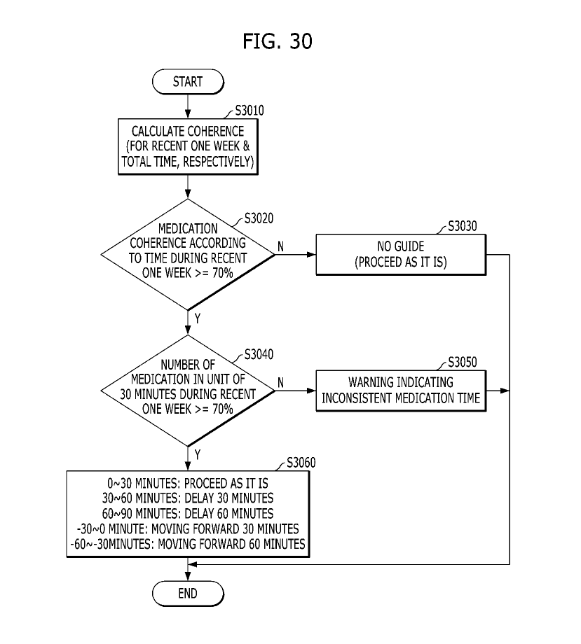

FIGS. 29 and 30 are diagrams for explaining a process of recommending an automatic medication time change according to one embodiment of the present invention.

When a difference between medication reservation time and actual medication time consistently occurs for more than prescribed time, a method of modifying the medication reservation time in accordance with the actual medication time is explained with reference to FIGS. 29 and 30.

First of all, as shown in FIG. 29, if a specific medicine has a consistent difference between medication time and reservation time, a warning icon 2910 is displayed in the vicinity of medication alarm time. If the warning icon 2910 is selected, a pop-up message is outputted to recommend time change. A process flow for implementing the time change shall be described later with reference to FIG. 30.

Coherence for at least one specific medicine is calculated for recent one week and total time, respectively [S3010].

Whether or not medication coherence according to time during recent one week is equal to or greater than 70% is determined [S3020]. If the aforementioned condition is not satisfied, it may proceed without a guide [S3030]. In particular, a warning indicating that medication time is not constant is not outputted.

On the contrary, if the determination of the step S3020 is satisfied, whether or not medication coherence in a unit of 30 minutes during recent one week is equal to or greater than 70% is determined [S3040]. If the aforementioned condition is not satisfied, a warning message indicating that medication time is not constant is outputted [S3050].

Meanwhile, if the step S3040 is satisfied, it may be able to recommend change of medication time according to a specific pattern reference described in the following.

For example, if medication is performed within 0 to 30 minutes from predetermined medication time, it may proceed as it is. If medication is performed within 30 to 60 minutes from the predetermined medication time, medication alarm time is automatically changed by delaying 30 minutes. Or, it may be able to output a message for inquiring a time change. Moreover, if medication is performed within 60 to 90 minutes from the predetermined medication time, medication alarm time is automatically changed by delaying 60 minutes. Or, it may be able to output a message for inquiring a time change. On the contrary, if medication is performed within 0 to 30 minutes prior to the predetermined medication time, medication alarm time is automatically changed by moving forward the medication alarm time as much as 30 minutes. Or, it may be able to output a message for inquiring a time change. If medication is performed within 60 to 30 minutes prior to the predetermined medication time, medication alarm time is automatically changed by moving forward the medication alarm time as much as 60 minutes. Or, it may be able to output a message for inquiring a time change [S3060].

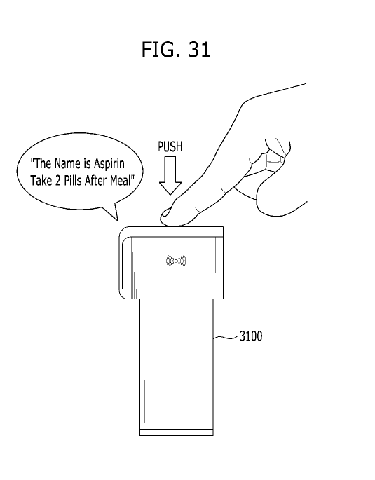

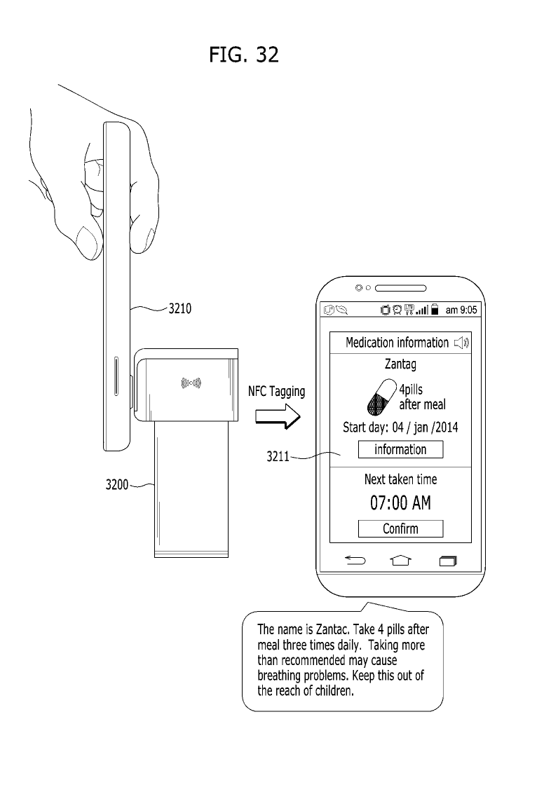

FIGS. 31 and 32 are diagrams for explaining a process of providing medication information by voice according to one embodiment of the present invention.

First of all, as shown in FIG. 31, if a button of a digital cap 3100 at which medication information is registered is clicked, simple medication information is guided by voice. The information is outputted via a speaker shown in the previously explained drawing.

Moreover, as shown in FIG. 32, medication information of the digital cap 3200 is displayed via a screen of the mobile device through NFC communication between the digital cap 3200 and the mobile device 3210. Of course, using RFID instead of the NFC also belongs to the scope of right of the present invention.

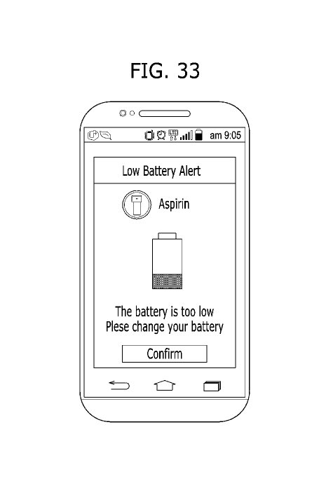

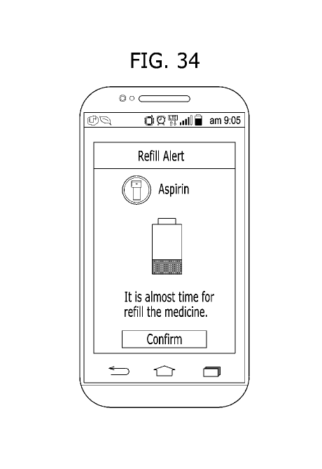

FIGS. 33 and 34 are diagrams for explaining a process of providing battery and refill warning according to one embodiment of the present invention. A process of generating a battery and refill warning message is explained in detail with reference to FIGS. 33 and 34.

First of all, if a level of a battery of a digital cap is equal to or less than a prescribed level, it may be able to configure the digital cap to autonomously flicker LED or generate a warning sound. Or, as shown in FIG. 33, it may be able to configure the mobile device to continuously monitor the battery of the digital cap. For example, if the level of the battery of the digital cap is equal to or less than a prescribed value, the digital cap transmits relevant information to the mobile device and, as shown in FIG. 33, the mobile device displays low battery for specific medication mapped to the digital cap.

Moreover, if the remaining amount of specific medication is small, as shown in FIG. 34, the mobile device outputs a relevant message. For example, when specific medication is registered at the mobile device, one time dosage, number of medication, and the total number of medicines are registered as well. And, since the mobile device is able to receive on/off information of a lid of the digital cap, it may be able to detect a case that a level of specific medication is reduced more than 80% on the basis of a first load. Of course, the aforementioned number is just an example only. The number can be changed to a different number. And, it may add a weight detecting sensor to the digital cap to more precisely calculate the amount of load. This also belongs to a different scope of right of the present invention.

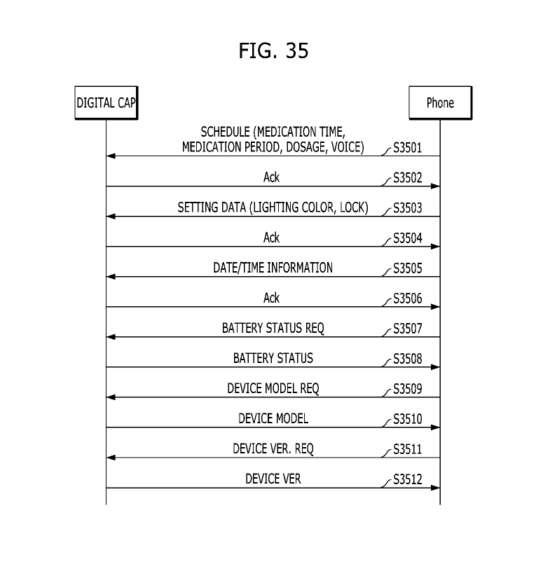

FIG. 35 is a flowchart for a method of pairing a digital cap and a mobile device according to one embodiment of the present invention. Of course, a part of the steps shown in FIG. 35 can be deleted to implement a different scope of right of the present invention. Or, changing an order of the steps also belongs to a further different scope of right of the present invention.

First of all, assume that a data pairing between a mobile device and a digital cap has been completed. In this case, the mobile device transmits such information as a schedule (medication time, medication period, dosage, etc.) [S3501]. The information can be registered by a user in advance. Or, if the mobile device recognizes a barcode of medication, it is sufficient.

The digital cap transmits an ACK confirmation signal [S3502] and the mobile device transmits a setting data (e.g., lighting color, information on whether or not the mobile device is locked) [S3503]. The digital cap transmits an ACK confirmation signal again [S3504].

The mobile device transmits a date, time information, and the like to the digital cap [S3505] and the digital cap transmits an ACK confirmation signal to the mobile device [S3506].

The mobile device transmits a battery status request signal of the digital cap to the digital cap [S3507] and the digital cap transmits information on a battery status to the mobile device [S3508].

The mobile device transmits a signal for requesting model information of the digital cap to the digital cap [S3509] and the digital cap is configured to transmit the model information to the mobile device [S3510].

And, the mobile device transmits a signal for requesting version information of the digital cap to the digital cap [S3511] and the digital cap is configured to transmit the version information to the mobile device [S3512].

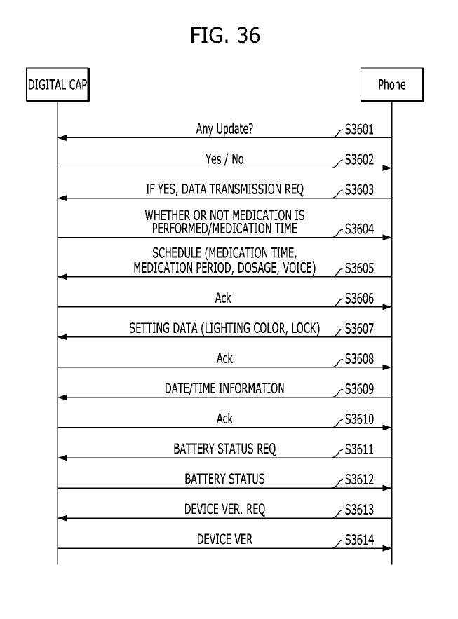

FIG. 36 is a flowchart for a method of transmitting update information transmitted by a digital cap and a mobile device according to one embodiment of the present invention. Of course, a part of the steps shown in FIG. 36 can be deleted to implement a different scope of right of the present invention. Or, changing an order of the steps also belongs to a further different scope of right of the present invention.

Unlike FIG. 35, FIG. 36 assumes that update information occurs at the digital cap.

First of all, the mobile device transmits a message for asking whether or not there is update information to the digital cap [S3601] and the digital cap transmits a response message to the mobile device in response to the message [S3602].

If there is update information, the mobile device transmits a message for asking specific update information to the digital cap [S3603] and the digital cap transmits information on whether or not medication is performed (e.g., such an action of opening and closing a lid) and mediation time information to the mobile device [S3604].

The mobile device transmits a schedule (medication time, medication period, dosage, etc.) to the digital cap [S3605]. The information can be registered by a user in advance. Or, if the mobile device recognizes a barcode of medication, it is sufficient.

The digital cap transmits an ACK confirmation signal [S3606] and the mobile device transmits a setting data (e.g., lighting color, information on whether or not the mobile device is locked) [S3607]. The digital cap transmits an ACK confirmation signal again [S3608].

The mobile device transmits a date, time information, and the like to the digital cap [S3609] and the digital cap transmits an ACK confirmation signal to the mobile device [S3610].

The mobile device transmits a battery status request signal of the digital cap to the digital cap [S3611] and the digital cap transmits information on a battery status to the mobile device [S3612].

And, the mobile device transmits a signal for requesting version information of the digital cap to the digital cap [S33613] and the digital cap is configured to transmit the version information to the mobile device [S3614].

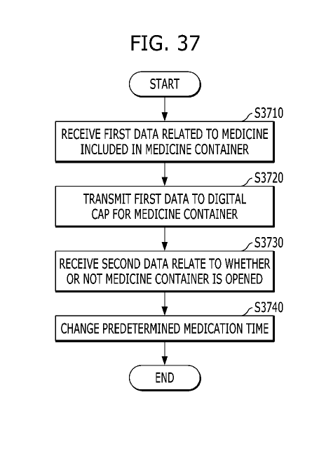

FIG. 37 is a flowchart for a method of controlling a mobile device according to one embodiment of the present invention. Of course, a part of the steps shown in FIG. 37 can be deleted to implement a different scope of right of the present invention. Or, changing an order of the steps also belongs to a further different scope of right of the present invention. And, it may be able to complementally interpret FIG. 37 with reference to the aforementioned digital cap or the mobile device.

First of all, a first data indicating a type of medicine included in a medicine container or medication time is received [S3710] and the received data is transmitted to a digital cap for the medicine container [S3720].

A second data indicating whether or not the medicine container is opened is received from the digital cap [S3730] and the medication time is changed based on the received second data [S3740].

Although it is not depicted in FIG. 37, if a third data indicating a type of a medicine identical to the medicine of the first data is received, a method of controlling a mobile device can further include the step of displaying a warning message.

Although it is not depicted in FIG. 37, the method of controlling the mobile device can further include the step of displaying an option capable of changing a display color of the digital cap according to the type of the medicine.

Although it is not depicted in FIG. 37, the method of controlling the mobile device can further include the steps of storing information on opening/closing time of the medicine container received from the digital cap and changing the medication time of the first data based on the stored information.

Although it is not depicted in FIG. 37, the method of controlling the mobile device can further include the step of, if the remaining power of a battery of the digital cap is equal to or less than a predetermined value or if the number of medicines included in the medicine container is equal to or less than a predetermined value, outputting a warning alarm in an audio form or a video form. The outputting step can further include the step of calculating the remaining amount of the medicines included in the medicine container based on the total number of firstly registered medicines, information on one time dosage, and the count of opening/closing the medicine container.

Although it is not depicted in FIG. 37, the method of controlling the mobile device can further include the step of determining whether or not the medicine container is opened at the received medication time.

Although it is not depicted in FIG. 37, the method of controlling the mobile device can further include the step of, if a probability of opening the medicine container at the medication time satisfies a first range (e.g., equal to or less than 70%), displaying a data indicating a relevant result. If the probability of opening the medicine container at the medication time satisfies a second range (e.g., equal to or less than 50%), the method of controlling the mobile device can further include the step of transmitting a data indicating a relevant result to a different external device. Regarding this, it may refer to the contents mentioned earlier in FIG. 25.

The method of controlling the mobile device can further include the step of displaying a first option for controlling the first range or the second range and a second option for specifying the different external device. Regarding this, it may refer to the contents mentioned earlier in FIG. 28.

The present invention mentioned can be implemented by codes readable by a computer in media in which a program is recorded. Of course, downloading in an application form also belongs to the scope of right of the present invention. Media readable by a computer includes all kinds of recording devices in which data readable by a computer system is stored. Examples of the media readable by a computer include a HDD (hard disk drive), an SSD (solid state disk), an SDD (silicon disk drive), a ROM, a RAM, a CD-ROM, a magnetic tape, a floppy disk, an optical data storing device and the like. And, the media can be implemented in a form of a carrier wave (e.g., transmission via the internet). And, the computer may include a controller of a terminal. While the present specification has been described and illustrated herein with reference to the preferred embodiments and diagrams thereof, the present specification may be non-limited to the aforementioned embodiments and it will be apparent to those skilled in the art that various modifications and variations can be made therein without departing from the spirit and scope of the present specification. Thus, it is intended that the present specification covers the modifications and variations of this invention that come within the scope of the appended claims and their equivalents.

### MODE FOR INVENTION

In the aforementioned table of contents, various forms for implementing the invention are described together.

### INDUSTRIAL APPLICABILITY

Since the present invention is applicable to a digital cap for a medicine container and a mobile device (e.g., a cellular phone, a tablet PC, a notebook, etc.), the present invention is industrially usable.

What is claimed is:

1. A digital cap for a medicine container, comprising:
a fastening module capable of being connected with the medicine container;
a communication module configured to receive at least one of a type of medicines contained in the medicine container and medication time from a mobile device;
a detect module configured to detect whether or not the connected medicine container is opened/closed;
if whether or not the connected medicine container is opened/closed is detected and current time is not a range of the received medication time, an output module configured to output an alarm for setting a limit on medication;
a controller configured to control the communication module to transmit information on whether or not the connected medicine container is opened/closed to the mobile device; and
a battery configured to supply power to at least one of the aforementioned configuration elements.

2. The digital cap of claim 1, wherein the output module corresponds to at least one of a speaker and a display.

3. The digital cap of claim 2, wherein if a level of the remaining power of the battery is equal to or less than a predetermined level or the number of medicines contained in the medicine container is equal to or less than a predetermined number, the output module is configured to output a warning alarm in an audio form or a video form.

4. The digital cap of claim 3, wherein the controller is configured to calculate the remaining amount of the medicines contained in the medicine container based on the total number of firstly registered medicines, information on one time dosage, and the count of opening/closing the digital cap detected by the detect module.

5. The digital cap of claim 1, further comprising a memory in which the medication time is stored.

6. The digital cap of claim 5, wherein the controller is configured to update time of opening/closing the medicine container in the memory and change the received medication time based on the updated information.

7. The digital cap of claim 1, wherein the controller is configured to determine whether or not the medicine container is opened at the received medication time.

8. The digital cap of claim 7, wherein if a probability of opening/closing the medicine container at the medication time satisfies a first range, the communication module is configured to transmit a data indicating a relevant result to the mobile device.

9. The digital cap of claim 8, wherein if the probability of opening/closing the medicine container at the medication time satisfies a second range, the communication module is configured to transmit the data indicating the relevant result to a different external device rather than the mobile device.

10. The digital cap of claim 1, wherein the communication module is configured to perform communication with the mobile device based on NFC or Bluetooth.

11. A method of controlling a mobile device, comprising the steps of:
receiving a first data indicating a type of medicine contained in a medicine container or medication time;
transmitting the received data to a digital cap for the medicine container;
receiving a second data indicating whether or not the medicine container is opened/closed from the digital cap; and
changing the medication time based on the received second data.

12. The method of claim 11, if a third data indicating a type of medicine identical to the first data is received, further comprising the step of displaying a warning message.

13. The method of claim 11, further comprising the step of displaying an option capable of changing a display color of the digital cap according to the type of medicine.

14. The method of claim 11, further comprising the steps of:
storing information on time of opening/closing the medicine container received from the digital cap; and
changing the medication time of the first data based on the stored information.

15. The method of claim 11, if a level of the remaining power of a battery of the digital cap is equal to or less than a predetermined level or the number of medicines contained in the medicine container is equal to or less than a predetermined number, further comprising the step of outputting a warning alarm in an audio form or a video form.

16. The method of claim 15, wherein the outputting step further comprises the step of calculating the remaining amount of the medicines contained in the medicine container based on the total number of firstly registered medicines, information on one time dosage, and the count of opening/closing the digital cap.

17. The method of claim 11, further comprising the step of determining whether or not the medicine container is opened at the received medication time.

18. The method of claim 17, if a probability of opening/closing the medicine container at the medication time satisfies a first range, further comprising the step of displaying a data indicating a relevant result.

19. The method of claim 18, if the probability of opening/closing the medicine container at the medication time satisfies a second range, further comprising the step of transmitting the data indicating the relevant result to a different external device.

20. The method of claim 19, further comprising the step of displaying a first option for controlling the first range or the second range and a second option for specifying the different external device.
